(19) United States
(12) Patent Application Publication
(10) Pub. No.: US 2024/0390860 A1
(43) Pub. Date: Nov. 28, 2024

(54) POLYIMIDE-BASED MEMBRANES FOR DESALINATION

(71) Applicant: KING FAHD UNIVERSITY OF PETROLEUM AND MINERALS, Dhahran (SA)

(72) Inventors: Turki Nabieh BAROUD, Dhahran (SA); Mahmoud Atef ABDULHAMID, Dhahran (SA); Mohammed Abdul AZEEM, Dhahran (SA); Obidara Toheeb OLUMIDE, Dhahran (SA)

(73) Assignee: KING FAHD UNIVERSITY OF PETROLEUM AND MINERALS, Dhahran (SA)

(21) Appl. No.: 18/364,639

(22) Filed: Aug. 3, 2023

Related U.S. Application Data
(60) Provisional application No. 63/468,657, filed on May 24, 2023.

(51) Int. Cl. B01D 67/00; B01D 61/36; B01D 69/02; B01D 71/64; C02F 1/44

(52) U.S. Cl. CPC B01D 67/00111; B01D 61/3641; B01D 67/0013; B01D 69/02; B01D 71/64; C02F 1/447; B01D 2313/22; B01D 2325/022; B01D 2325/02834; B01D 2325/04; C02F 2103/08; C02F 2103/10

(57) ABSTRACT

A method of making a polyimide membrane includes mixing dianhydride and phenylenediamine monomers in a first solvent to form a mixture; heating the mixture thereby polymerizing to form a polyimide polymer in a crude mixture; precipitating and separating the polyimide polymer from the crude mixture; mixing and dissolving the polyimide polymer in a second solvent to form a polyimide solution; applying the polyimide solution onto a surface of a substrate to form a polyimide liquid layer on the substrate; immersing the substrate after the applying in at least one liquid medium selected from the group consisting of water and alcohol, thereby precipitating the polyimide polymer from the polyimide solution to form the polyimide membrane disposed on the surface of the substrate. A desalination system containing the polyimide membrane, and a desalination process.

### CROSS-REFERENCE TO RELATED APPLICATIONS

The present application claims the priority of U.S. Provisional Patent Application No. 63/468,657, having a filing date of May 24, 2023, which is incorporated herein by reference in its entirety.

### BACKGROUND

### Technical Field

The present disclosure is directed to a filtration membrane, particularly a polyimide-based membrane for desalination.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Water desalination is is experiencing rapid development in response to the need for freshwater to meet the demands of human consumption. The water shortage has emerged as one of the most critical global challenges of our time. Among the available water treatment technologies, desalination has gained significant recognition as the most effective method for providing safe drinking water. This process involves the use of various membrane technologies, including reverse osmosis, nanofiltration, membrane distillation, and forward osmosis, which play a crucial role in purifying water. Over the last few decades, membrane-based technologies have undergone substantial growth due to their exceptional advantages, such as high separation efficiency, low operating costs, and improved ease of use.

Membrane distillation (MD) is a thermally-driven process, wherein only vapor molecules can transport across the porous membranes under a vapor pressure gradient. Commonly used polymers for the MD membranes include but are not limited to polypropylene, polyvinylidene fluoride, polytetrafluoroethylene (PTFE), and polyimides due to their inherent hydrophobicity. MD need to possess features such as low fouling rate, high permeability, low thermal conductivity, high liquid entry pressure, and thermal and chemical stability.

The major challenges faced in membrane technologies are the formation of fouling and membrane wetting on the surface of membranes. Pore wetting of membranes can be improved by reducing the pore diameter and enhancing the hydrophobicity of membranes. Ensuring avoidance of pore wetting is essential for achieving high flux, stable salt rejection, and excellent membrane performance. The characteristics of the polymer determine the selectivity and permeability for separation purposes, including gas and liquid applications. The membranes developed for MD are predominantly produced by electrospinning and phase inversion routes. In a phase inversion based process, a thermodynamically stable polymer solution is carefully transformed from a liquid state to a solid state in a controlled manner. Factors such as solution concentration, cast polymer thickness, solvent types, and the chosen substrate can significantly influence the morphology and performance of the membranes in the phase inversion process.

Furthermore, the selection of materials and membrane pore sizes depends on the intended purposes. The average pore size range for MD membranes is between 0.1 and 1 micrometer (μm). To overcome the problem of pore wetting, it is important to develop membranes with optimal performance. Porous membranes made from polyimides have been fabricated to separate gases, vapors, and liquids due to their unique properties. Polyimide membranes exhibit exceptional resistance to various chemical agents, and their heat resistance allows for extended separations at elevated temperatures.

Polyimides are considered high-performance materials due to their outstanding features, making them suitable for creating innovative membrane types for gas separation, desalination, and wastewater treatment. Their thermal and mechanical performances have recently attracted interest for separation applications. Polyimide membranes have also demonstrated successful use in reverse osmosis applications. For instance, Ba et al. synthesized thermally stable composite reverse osmosis (RO) membranes using PMDA/ODA polyimides [Ba C, Economy J. Preparation of PMDA/ODA polyimide membrane for use as substrate in a thermally stable composite reverse osmosis membrane. J Memb Sci 2010; 363:140-8].

The exceptional thermal, chemical, and mechanical properties of polyimide make it an ideal material for membrane distillation. In general, polyimide membranes exhibit good antifouling properties and achieve appropriate water flux, further enhancing their suitability for membrane applications.

Additionally, polyimide membranes from 6FDA are employed in nanofiltration due to their high chemical resistance to numerous organic solvents such as hydrocarbons and alcohol [White LS. Transport properties of a polyimide solvent-resistant nanofiltration membrane. vol. 205. 2002]. Polyimides with CF₃ groups may have improved chain stiffness, and thus reducing the chain packing [Xiao Y, Low B T, Hosseini S S, Chung T S, Paul D R. The strategies of molecular architecture and modification of polyimide-based membranes for CO₂ removal from natural gas-A review. Progress in Polymer Science (Oxford) 2009; 34:561-80].

Although a few polyimide membranes have been developed in the past, there remains a critical need to develop porous membranes with enhanced characteristics. Specifically, the development of membranes that exhibit high flux, exceptional permeability, and stable rejection performance.

In view of the foregoing, it is one objective of the presend disclosure to describe a method of making a polyimide membrane. Another objective of the present disclosure is to describe a desalination system, and a desalination process.

### SUMMARY

In an exemplary embodiment, a method of making a polyimide membrane is described. The method includes mixing at least one dianhydride monomer and at least one phenylenediamine monomer in a first solvent to form a mixture. In some embodiments, a molar ratio of the dianhydride monomer and the phenylenediamine monomer present in the mixture is in a range of 1:5 to 5:1. The method includes heating the mixture thereby polymerizing the dianhydride and phenylenediamine monomers to form the polyimide polymer in a crude mixture; precipitating the polyimide polymer from the crude mixture to separate the polyimide polymer from the crude mixture; mixing and dissolving the polyimide polymer in a second solvent to form a polyimide solution; applying the polyimide solution onto a surface of a substrate to form a polyimide liquid layer on the substrate; immersing the substrate after the applying in at least one liquid medium selected from the group consisting of water and alcohol, thereby precipitating the polyimide polymer from the polyimide solution to form the polyimide membrane disposed on the surface of the substrate; and removing the polyimide membrane from the surface of the substrate. In some embodiments, the polyimide membrane has a thickness in a range of 30 to 100 micrometers (μm).

In some embodiments, the dianhydride is at least one selected from the group consisting of 4,4′-(hexafluroisopropylidene)diphthalic anhydride (6FDA), 4,4′-(4,4′-isopropylidenediphenoxy)bis(phthalic anhydride), and benzophenone-3,3′,4,4′-tetracarboxylic dianhydride, and wherein the mixture consists of the dianhydride monomer, the phenylenediamine monomer and the solvent.

In some embodiments, the phenylenediamine is a p-phenylenediamine having a formula (I)

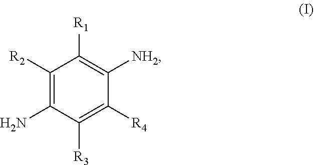

wherein R₁, R₂, R₃, and R₄ are each independently selected from the group consisting of a hydrogen, a hydroxy, an optionally substituted alkyl, an optionally substituted cycloalkyl, and an optionally substituted alkoxy, and wherein the polyimide consists of reacted units of the dianhydride monomer and the phenylenediamine monomer.

In some embodiments, the phenylenediamine is 2,3,5,6-tetramethyl-p-phenylenediamine (TMPD).

In some embodiments, the first solvent is at least one selected from the group consisting of m-cresol, o-cresol, p-cresol, 3,4-xylenol, 2,6-xylenol, and 2,5-xylenol.

In some embodiments, the method includes heating the mixture at a temperature of 180 to 220° C.

In some embodiments, the second solvent is at least one selected from the group consisting of dimethylformamide (DMF), and dimethyl sulfoxide (DMSO).

In some embodiments, the polyimide polymer is present in the polyimide solution at a concentration of 1 to 20 wt. % based on a total weight of the polyimide solution.

In some embodiments, the liquid medium is an alcohol, and wherein the alcohol is at least one selected from the group consisting of methanol, ethanol, n-propanol, i-propanol, n-butanol, and tert-butanol.

In some embodiments, the polyimide membrane has a thickness in a range of 40 to 80 μm. In some embodiments, the polyimide membrane has a porous surface with a maximum pore size of 0.1 to 0.3 μm.

In some embodiments, the polyimide membrane has a porosity of 80 to 90% based on a total volume of the polyimide membrane.

In some embodiments, the polyimide membrane has a water contact angle of 93 to 98°.

In some embodiments, the polyimide membrane has a liquid entry pressure (LEP) in a range of 0.5 to 2.5 bar, as determined by a capillary flow porometer.

In some embodiments, the polyimide membrane has a permeate flux of 9 and 15 Kg/m²h.

In an exemplary embodiment, a desalination system is described. The desalination system includes an air gap membrane distillation (AGMD) unit having a plurality of modules. Each module includes a hot liquid compartment (HC) having a hot liquid inlet and a hot liquid outlet; a condensation plate (CP) having a first side and a second side opposite the first side. In some embodiments, the polyimide membrane having a thickness of 40 to 80 μm disposed on at least one side of the HC. In some embodiments, one side of the polyimide membrane faces to the first side of the CP. The desalination system further includes an air gap compartment (AG) separates the CP and the polyimide membrane; a cold liquid compartment (CC) having a cold liquid inlet and a cold liquid outlet. In some embodiments, the CC is adjacent to the second side of the CP. Additionally, the desalination system includes a permeate outlet in fluid communication with the air gap; a heating unit in fluid communication with the HC; and a cooling unit in fluid communication with the CC.

In some embodiments, the plurality of modules of the AGMD unit are connected in at least one of a series arrangement or a parallel arrangement.

In some embodiments, water produced from the first side of the CP of the module is collected at a permeate tank via a permeate outlet of the AG of the same module.

In some embodiments, a desalination process is described. The desalination process includes feeding a liquid into the desalination system through the hot liquid inlet of the HC; and collecting distilled water from the permeate outlet. In some embodiments, the liquid is at least one selected from the group consisting of salty water, ocean/sea water, rejected brine, wastewater, brackish water, flowback/produced water, and waste flows.

In some embodiments, the liquid is a salty water containing sodium chloride (NaCl). In some embodiments, the NaCl is present in the salty water at a concentration of 0.1 to 100 grams per liter (g/L) based on a total volume of the salty water.

The foregoing general description of the illustrative present disclosure and the following The detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method of making a polyimide membrane, according to certain embodiments;

FIG. 2 depicts a schematic illustration of an air gap membrane distillation (AGMD) system, according to certain embodiments;

FIG. 3 is a schematic illustration depicting a dope solution preparation and membrane casting of 4,4′-(hexafluoroisopropylidene)diphthalic anhydride-N,N,N′,N′-tetramethyl-p-phenylenediamine (6FDA-TMPD) membrane, according to an embodiment of the present disclosure;

FIG. 4A shows a scanning electron microscope (SEM) image of the 6FDA-TMPD membrane surface fabricated from water as a non-solvent medium, according to certain embodiments;

FIG. 4B shows a surface SEM image of the 6FDA-TMPD membrane fabricated from ethanol as a non-solvent medium, according to certain embodiments;

FIG. 4C shows a cross-sectional SEM image of the 6FDA-TMPD membrane surface fabricated from water as a non-solvent medium, according to certain embodiments;

FIG. 4D shows a cross-sectional SEM image of the 6FDA-TMPD membrane surface fabricated from ethanol as a non-solvent medium, according to certain embodiments;

FIG. 5A shows a surface SEM image of the membrane fabricated with 8 wt. % of 6FDA-TMPD polymer, according to certain embodiments;

FIG. 5B shows a surface SEM image of the membrane fabricated with 10 wt. % of 6FDA-TMPD polymer, according to certain embodiments

FIG. 5C shows a surface SEM image of the membrane fabricated with 12 wt. % of 6FDA-TMPD polymer, according to certain embodiments;

FIG. 5D shows a cross-sectional SEM image of the membrane fabricated with 8 wt. % of 6FDA-TMPD polymer, according to certain embodiments;

FIG. 5E shows a cross-sectional SEM image of the membrane fabricated with 10 wt. % of 6FDA-TMPD polymer, according to certain embodiments;

FIG. 5F shows a cross-sectional SEM image of the membrane fabricated with 12 wt. % of 6FDA-TMPD polymer, according to certain embodiments;

FIG. 6 shows a Fourier Transform Infrared (FTIR) spectroscopy of the 6FDA-TMPD membranes in water and ethanol baths, according to certain embodiments;

FIG. 7A shows a contact angle of the 6FDA-TMPD membrane cast on glass with water as a coagulation bath, according to certain embodiments;

FIG. 7B shows a contact angle of the 6FDA-TMPD membrane cast on glass with ethanol as a coagulation bath, according to certain embodiments;

FIG. 7C shows a DI water droplet on 6FDA-TMPD polyimide membranes cast on glass with 8. wt % of the 6FDA-TMPD polymer, according to certain embodiments;

FIG. 7D shows a DI water droplet on 6FDA-TMPD polyimide membranes cast on glass with 10. wt % of the 6FDA-TMPD polymer, according to certain embodiments;

FIG. 7E shows a DI water droplet on 6FDA-TMPD polyimide membranes cast on glass with 12. wt % of the 6FDA-TMPD polymer, according to certain embodiments;

FIG. 8 shows rejection and permeate flux of the 6FDA-TMPD membrane using water and ethanol as a non-solvent medium, according to certain embodiments;

FIG. 9 is a plot depicting rejection and permeate flux of the membrane with 12 wt. %, 10 wt. %, and 8 wt. % concentration of the 6FDA-TMPD polymer, in ethanol nonsolvent medium, according to certain embodiments;

FIG. 10 is a plot depicting the effect of casting thickness on rejection and permeate flux of the membrane with 10 wt. % concentration of the 6FDA-TMPD polymer, according to certain embodiments; and

FIG. 11 shows flux and rejection for the 6FDA-TMPD membrane tested with real seawater as feed, according to certain embodiments.

### DETAILED DESCRIPTION

In the drawings, reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “membrane” as used herein refers to a porous structure that is capable of separating components of a homogeneous or heterogeneous fluid. In particular, “pores” in the sense of the present disclosure indicate voids allowing fluid communication between different sides of the structure. More particular in use when a homogeneous or heterogeneous fluid is passed through the membrane, some components of the fluid can pass through the pores of the membrane into a “permeate stream”, while some components of the fluid can be retained by the membrane and can thus accumulate in a “retentate” and/or some components of the fluid can be rejected by the membrane into a “rejection stream”. Membranes can be of various thicknesses, with homogeneous or heterogeneous structures. Membranes can be in the form of flat sheets or bundles of hollow fibers. Membranes can also be in various configurations, including but not limited to spiral wound, tubular, hollow fiber, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, the term “filtration” refers to the mechanical or physical operation which can be used for separating components of homogeneous or heterogeneous solutions.

As used herein, the term “substituted” refers to at least one hydrogen atom that is replaced with a non-hydrogen group, provided that normal valences are maintained and that the substitution results in a stable compound. When a substituent is noted as “optionally substituted”, the substituents are selected from the exemplary group including, but not limited to, halo, hydroxyl, alkoxy, oxo, alkanoyl, aryloxy, alkanoyloxy, amino, alkylamino, arylamino, arylalkylamino, disubstituted amines (e.g. in which the two amino substituents are selected from the exemplary group including, but not limited to, alkyl, aryl or arylalkyl), alkanylamino, aroylamino, aralkanoylamino, substituted alkanoylamino, substituted arylamino, aubstituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide (e.g. —SO₂NH₂), substituted sulfonamide, nitro, cyano, carboxy, carbamyl (e.g. —CONH₂), substituted carbamyl (e.g. —CONHalkyl, —CONHaryl, —CONHarylalkyl or cases where there are two substituents on one nitrogen from alkyl, aryl, or alkylalkyl), alkoxycarbonyl, aryl, substituted aryl, guanidine, heterocyclyl (e.g. indolyl, imidazoyl, furyl, thienyl, thiazolyl, pyrrolidyl, pyridyl, pyrimidiyl, pyrrolidinyl, piperidinyl, morpholinyl, piperazinyl, homopiperazinyl and the like), substituted heterocyclyl and mixtures thereof and the like. The substituents may themselves be optionally substituted and may be either unprotected or protected as necessary, as known to those skilled in the art, for example, as taught.

As used herein, the term “alkyl” unless otherwise specified refers to both branched and straight chain saturated aliphatic primary, secondary, and/or tertiary hydrocarbons of typically C1 to C20, preferably C6-C18, more preferably C10-C16, for example C1, C2, C3, C4, C5, C6, C7, C8, C9, C10, C11, C12, and specifically includes, but is not limited to, methyl, trifluoromethyl, ethyl, propyl, isopropyl, cyclopropyl, butyl, isobutyl, t-butyl, pentyl, cyclopentyl, isopentyl, neopentyl, hexyl, isohexyl, cyclohexyl, cyclohexylmethyl, 3-methylpentyl, 2,2-dimethylbutyl, 2,3-dimethylbutyl, 2-ethylhexyl, heptyl, octyl, nonyl, 3,7-dimethyloctyl, decyl, undecyl, dodecyl, tridecyl, 2-propylheptyl, tetradecyl, pentadecyl, hexadecyl, heptadecyl, octadecyl, nonadecyl, and eicosyl. As used herein, the term optionally includes substituted alkyl groups. Exemplary moieties with which the alkyl group can be substituted may be selected from the group including, but not limited to, hydroxyl, amino, alkylamino, arylamino, alkoxy, aryloxy, nitro, cyano, sulfonic acid, sulfate, phosphonic acid, phosphate, halo, or phosphonate or mixtures thereof. The substituted moiety may be either protected or unprotected as necessary, and as known to those skilled in the art.

The term “cycloalkyl” refers to cyclized alkyl groups. Exemplary cycloalkyl groups include, but are not limited to, cyclopropyl, cyclobutyl, cyclopentyl, cyclohexyl, norbornyl, and adamantyl. Branched cycloalkyl groups, such as exemplary 1-methylcyclopropyl and 2-methylcyclopropyl groups, are included in the definition of cycloalkyl as used in the present disclosure.

The term “alkoxy” refers to a straight or branched chain alkoxy including, but not limited to, methoxy, ethoxy, propoxy, isopropoxy, butoxy, isobutoxy, secondary butoxy, tertiary butoxy, pentoxy, isopentoxy, hexyloxy, heptyloxy, octyloxy, nonyloxy, and decyloxy.

Aspects of the present disclosure are directed to a porous polyimide membrane fabricated from the 6FDA-TMPD polymer by a non-solvent induced phase inversion process to form a membrane that is applicable for desalination of saline water by membrane distillation (MD). The 6FDA-TMPD polymer has desirable hydrophobicity and intrinsic microporosity characteristics imparted by use of a phase inversion process for synthesis. A method of preparing the membrane is also disclosed. The 6FDA-TMPD polymer membrane performed exceptionally well in Air Gap Membrane Distillation system (AGMDs) for desalination of highly saline water (e.g., preferably about 70 g/L NaCl) with an improved permeate flux and stable salt rejection of preferably up to 99.97% based on initial concentration of the stable salt for more than 24 hours.

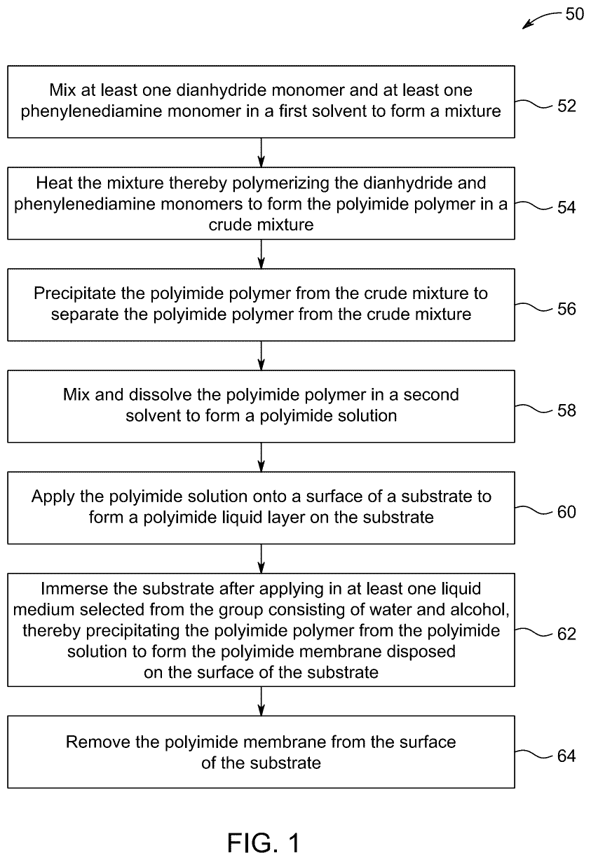

Referring to FIG. 1, a schematic flow diagram of a method of making a polyimide membrane is illustrated. The order in which the method 50 is described is not intended to be construed as a limitation, and any number of the described method steps may be combined in any order to implement the method 50. Additionally, individual steps may be removed or skipped from the method 50 without departing from the spirit and scope of the present disclosure.

At step 52, the method 50 includes mixing at least one dianhydride monomer and at least one phenylenediamine monomer in a first solvent to form a mixture. In some embodiments, the molar ratio of the dianhydride monomer and the phenylenediamine monomer present in the mixture is in a range of 1:10 to 10:1, preferably 1:5 to 5:1, preferably 4:1 to 1:4, preferably 3:1 to 1:3, preferably 2:1 to 1:2, preferably 1:1. Other ranges are also possible. In some embodiments, the dianhydride is one of 4,4′-(hexafluoroisopropylidene)diphthalic anhydride (6-FDA), 4,4′-(4,4′-isopropylidenediphenoxy)bis(phthalic anhydride), and benzophenone-3,3′,4,4′-tetracarboxylic dianhydride. Other examples of dianhydride monomers include 3,3′,4,4′-biphenyltetracarboxylic acid dianhydride (BPDA), 2,3,3′,4′-biphenyltetracarboxylic acid dianhydride, (a-BPDA), pyromellitic dianhydride, etc. In a preferred embodiment, the dianhydride is 6-FDA. In an embodiment, the weight percent of 6-FDA is in a range of 1-19 wt. %, preferably 5-15 wt. %, preferably 6-14 wt. %, preferably 7-14 wt. %, preferably 8-12 wt. % in the first solution. Other ranges are also possible. In some embodiments, the phenylenediamine monomer is p-phenylenediamine and is a compound of Formula (I)

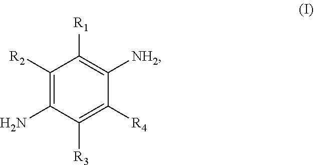

wherein R₁, R₂, R₃, and R₄ are each independently selected from the group consisting of a hydrogen, a hydroxy, an optionally substituted alkyl, an optionally substituted cycloalkyl, and an optionally substituted alkoxy. In a preferred embodiment, the phenylenediamine is 2,3,5,6-tetramethyl-p-phenylenediamine (TMPD).

In an embodiment, two or more dianhydride monomers may be mixed with two or more phenylenediamine monomers in the first solvent to form the mixture. In an embodiment, the dianhydride monomers may be the same or different. Similarly, the phenylenediamine monomers may be the same or different. In some embodiments, the first solvent is at least one selected from the group consisting of m-cresol, o-cresol, p-cresol, 3,4-xylenol, 2,6-xylenol, and 2,5-xylenol. In a preferred embodiment, the first solvent is m-cresol. The dianhydride monomer and the phenylenediamine monomer is mixed in the first solvent for 1-36 h, preferably 10-15 h, preferably 12-14 h, preferably 12 h, at a temperature range of 35-35° C., preferably 30° C., to obtain the mixture. Other ranges are also possible.

At step 54, the method 50 includes heating the mixture, thereby polymerizing the dianhydride and phenylenediamine monomers to form the polyimide polymer in a crude mixture. In an embodiment, the heating is performed at a temperature of 100 to 300° C., preferably 180 to 220° C., preferably 190-210° C., preferably 195-205° C., preferably 200° C. Other ranges are also possible. It is preferred that the heating is carried out in an inert atmosphere or under nitrogen flow to flush out undesired gases that are formed during the polymerization reaction. The polymerization reaction results in the formation of the polyimide polymer. The polyimide contains repeated units of reacted units of the dianhydride monomer and the phenylenediamine monomer. In an embodiment, the polymerization reaction is carried out in the presence of a catalyst, such as pyridine/isoquinoline, and a dehydrant, such as acetic anhydride.

At step 56, the method 50 includes precipitating the polyimide polymer from the crude mixture to separate the polyimide polymer from the crude mixture. The precipitation can be carried out using solvents like water, methanol, chloroform, or a mixture thereof. It is preferred to have the precipitation carried out multiple times, e.g., preferably 3 times, preferably 5 times, preferably 7 times, or even more preferably 9 times, to remove impurities, and m-cresol, to obtain the polyimide polymer. The subsequent steps explained here relate to the fabrication of the membrane.

At step 58, the method 50 includes mixing and dissolving the polyimide polymer in a second solvent to form a polyimide solution. In some embodiments, optionally, viscosity enhancers, and void suppressors, may be added to the second solvent to form the polyimide solution.

As used herein, the term “viscosity enhancer,” “thickener,” or “viscosity modifier” generally refer to a substance that can increase the viscosity or thickness of a mixture. In the present disclosure, the viscosity enhancers include but are not limited to xanthan gum, hydroxyethylcellulose (HEC), guar gum, bentonite, etc.

As used herein, the term “void suppressor,” or “air entraining agent” generally refer to a substance that can create a network of small, evenly distributed air voids within a mixture. In the present disclosure, the void suppressors include but are not limited to vinsol resins, wood resins, and synthetic air-entraining admixtures.

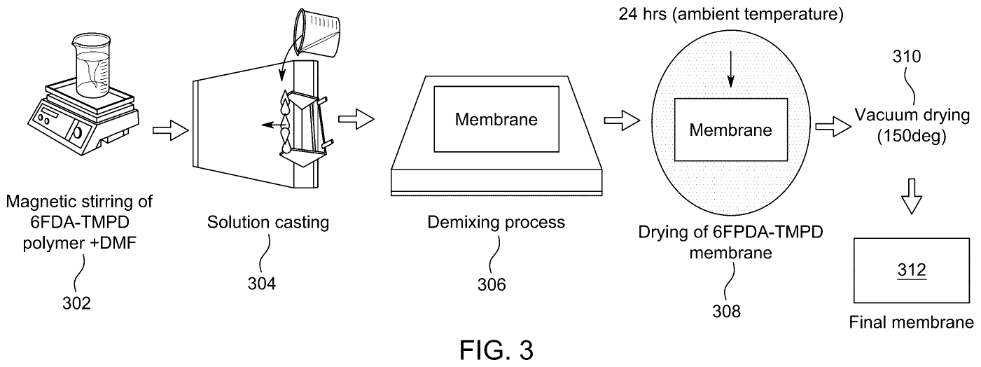

In some embodiments, the second solvent is at least one selected from the group consisting of dimethylformamide (DMF), and dimethyl sulfoxide (DMSO). In a preferred embodiment, the second solvent is DMF. Optionally, certain other examples of the second solvent, such as N-methyl-2-pyrrolidone, N-ethyl-2-pyrrolidinone, N,N-dimethylpropionamide, N,N-dimethylacetamide, tetrahydrofuran, 1,4 dioxane, γ-butyrolactone, water, alcohols, ketones, formamide, and mixtures thereof, may be used as well. Referring to FIG. 3, in some embodiments, the mixing was carried out for a period of 1 to 36 hours, preferably 8-15 hours, preferably 10-13 hours, preferably 10-12 hours, at a temperature of 25-35° C., preferably 28-32° C., preferably 30° C., to form the polyimide solution (302). Other ranges are also possible. In an embodiment, the polyimide polymer is present in the polyimide solution (302) at a concentration of 1 to 20 wt. %, preferably 2-18 wt. %, preferably 5-15 wt. %, preferably 8-12 wt. % based on the total weight of the polyimide solution. In an embodiment, the polyimide solution (302) is degassed to remove any air bubbles, and to prevent any defects in the membrane.

At step 60, the method 50 includes applying the polyimide solution (302) onto a surface of a substrate to form a polyimide liquid layer on the substrate (304), as depicted in FIG. 3. The substrate should preferably not hinder the passage of permeate through the membrane and not react with the polyimide solution, or the solvents which permeate through the membrane. Suitable examples of the substrate include metal mesh, sintered metal, porous ceramic, sintered glass, paper, porous non-dissolved plastic, and woven or non-woven material, such as polyester, polyethylene, polypropylene, polyolefin, polyetherether ketone (PEEK), polyphenyline sulphide (PPS), Ethylene-ChloroTriFluoroEthylene (Halar®ECTFE), or carbon fiber material. In an embodiment, the substrate is a glass surface. Optionally, the substrate (304) with the polyimide liquid layer may be evaporated to allow for evaporation of the solvents. The thickness of the polyamide liquid layer affects the performance of the membrane. In an embodiment, the polyamide liquid layer membrane has a thickness in a range of 20-1000 μm, preferably 50 to 500 μm, or even more preferably 150-250 μm. Other ranges are also possible.

At step 62, the method 50 includes, after the applying, immersing the substrate in at least one liquid medium selected from the group consisting of water and alcohol, thereby precipitating the polyimide polymer from the polyimide solution to form the polyimide membrane disposed on the surface of the substrate, as depicted in FIG. 3. In some embodiment, the liquid medium is an alcohol. The alcohol may be methanol, ethanol, n-propanol, iso-propanol, n-butanol, and tert-butanol. In some embodiments, the liquid medium is ethanol. In some embodiments, the liquid medium is water. In some other embodiments, the liquid medium may contain or consist of water, one or more ketones, or mixtures thereof.

In the present disclosure, the step 62 of the method 50 also refers to a demixing step. As used herein, the term “demixing,” or “demixing step” generally refers to a separation process that the solvent and non-solvent components separate or demix during the phase inversion process of fabricating membranes. During the demixing, when the polyimide DMF solution is exposed to water or ethanol as non-solvent media, the rate at which the solvent DMF and non-solvent (water or ethanol) separate or demix from each other is different, leading to the formation of polyimide membranes with different structures and properties.

At step 64, the method includes removing the polyimide membrane from the surface of the substrate, as depicted in FIG. 3. The polyimide membrane may be subsequently washed with a water-soluble organic compound such as low molecular weight alcohols and ketones, including but not limited to methanol, ethanol, isopropanol, acetone, methyl ethyl ketone or mixtures thereof for removing the residual solvent and other additives from the membrane. Alternatively, the membrane may be washed with water. Removal of the residual solvents may require successive wash blends, followed by drying to a temperature range of 100-200° C., preferably 120-280° C., preferably 130-160° C., preferably 140-150° C., preferably in a vacuum to obtain the membrane. Other ranges are also possible.

In some embodiments, the polyimide membrane has a thickness in a range of 10 to 200 micrometers (μm), preferably 30 to 100 μm, preferably 40 to 80 μm. Other ranges are also possible. In some embodiments, the polyimide membrane has a porous surface with a maximum pore size of 0.02 to 1 μm, preferably 0.05 to 0.5 μm, or even more preferably 0.1 to 0.3 μm. In some preferred embodiments, the polyimide membrane has a porosity of 80 to 90% based on a total volume of the polyimide membrane, preferably 82 to 88%, or even more preferably 84 to 86% based on the total volume of the polyimide membrane. In some more preferred embodiments, the polyimide membrane has a water contact angle of 80 to 110°, preferably 90 to 100°, or even more preferably 93 to 98°, as determined using sessile drop method. In some even more preferred embodiments, the polyimide membrane has a liquid entry pressure (LEP) in a range of 0.1 to 5 bar, preferably 0.5 to 2.5 bar, or even more preferably about 1.5 bar, as determined by a capillary flow porometer. In some most preferred embodiments, the polyimide membrane has a permeate flux of 5 to 20 Kg/m²h, preferably 9 and 15 Kg/m²h, or even more preferably about 12 Kg/m²h. Other ranges are also possible.

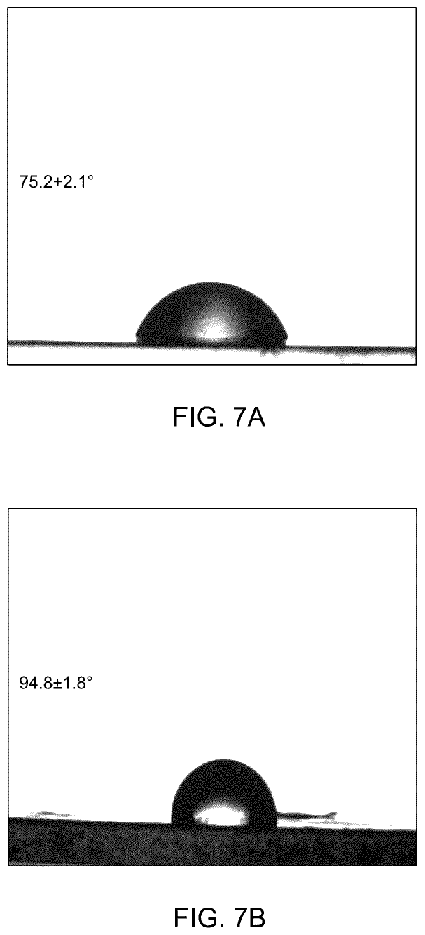

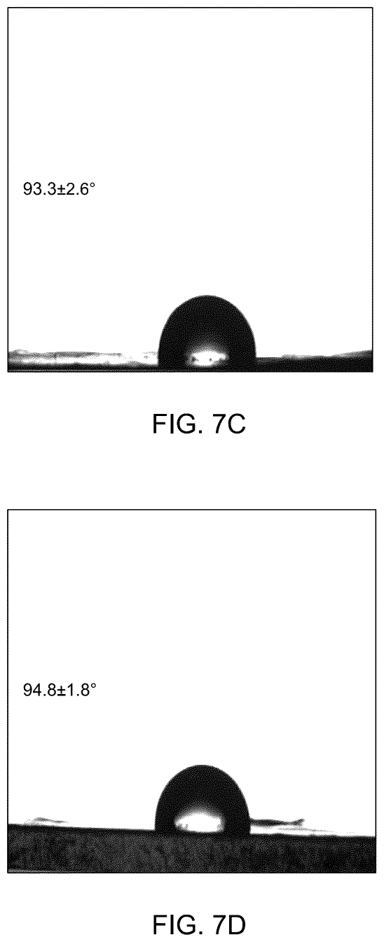

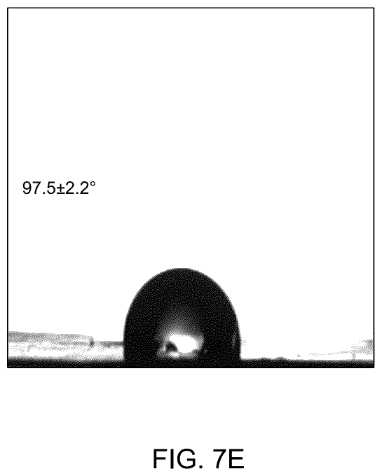

Referring to FIGS. 7A to 7E, the water contact angle was obtained by the sessile drop method on the polyimide membrane surface by using a contact angle goniometer instrument, e.g., DM-501, Kyowa Interface Science Co. Ltd., Japan. The water contact angle WCA was taken on at least two, preferably at least four different positions on the polyimide membrane and the average value was recorded. The thickness of the membranes was recorded by taking measurements from at least 5, preferably at least 10 different spots on the polyimide membrane to generate corresponding data using LITEMATIC VL-50A, manufactured by Mitutoyo measuring instrument.

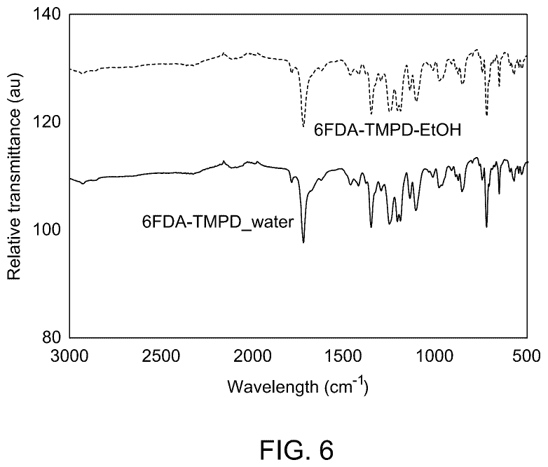

The structures of the polyimide membranes prepared from water and ethanol may be characterized by Fourier-transform infrared spectroscopy (FT-IR), respectively. In some embodiments, the FT-IR are collected in a Nicolet 6700 series acquired in a range of 4500 to 400 centimeter inverse (cm-1) at 4 cm-1 resolution. At least 5, at least 10, or preferably at least 20 scans were carried out for each sample. In some embodiments, the polyimide membrane prepared from water has peaks at 500 to 650 cm-1, 750 to 1400 cm-1 and 1500 to 2000 cm-1 in the FT-IR spectrum, confirming its formation as depicted in FIG. 6. In some embodiments, the polyimide membrane prepared from ethanol has peaks at 500 to 650 cm-1, 750 to 1400 cm-1 and 1500 to 2000 cm-1 in the FT-IR spectrum, confirming its formation as depicted in FIG. 6. Other ranges are also possible.

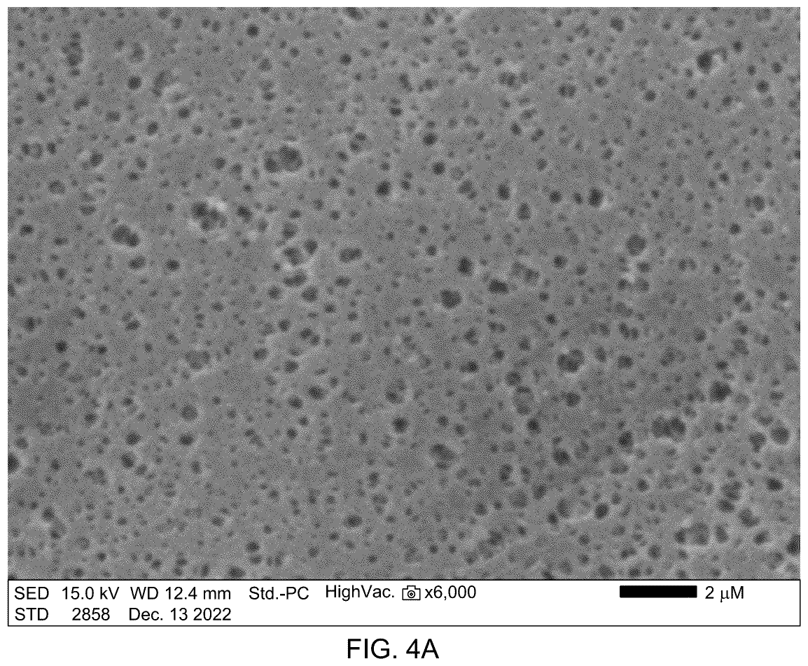

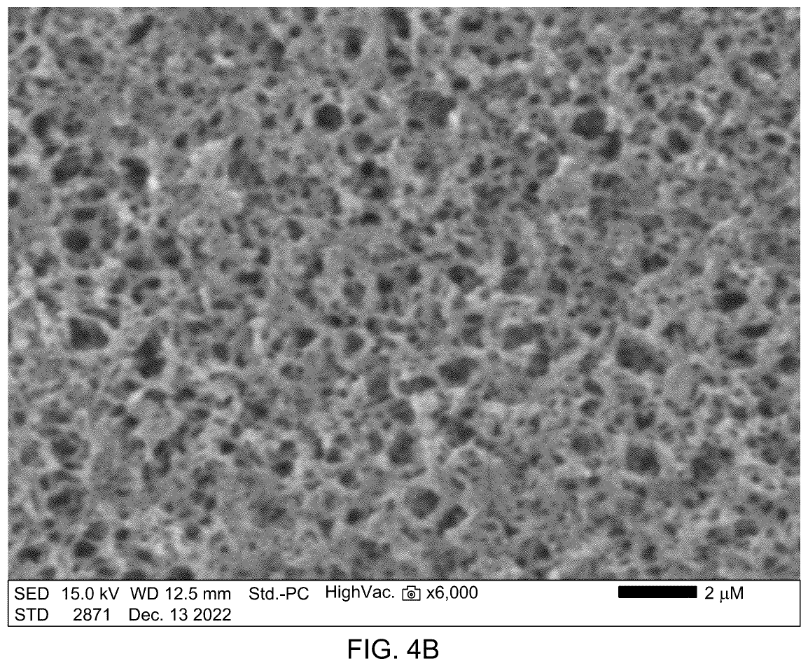

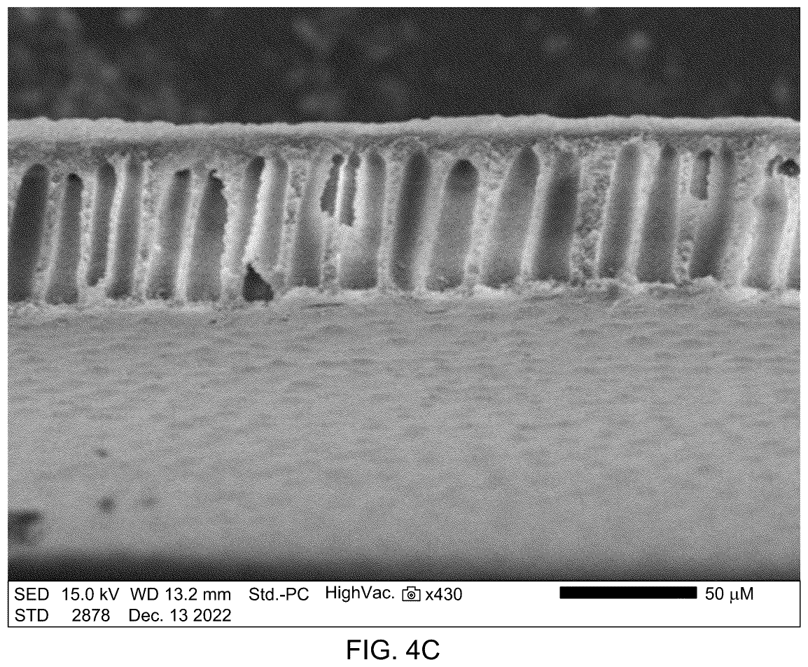

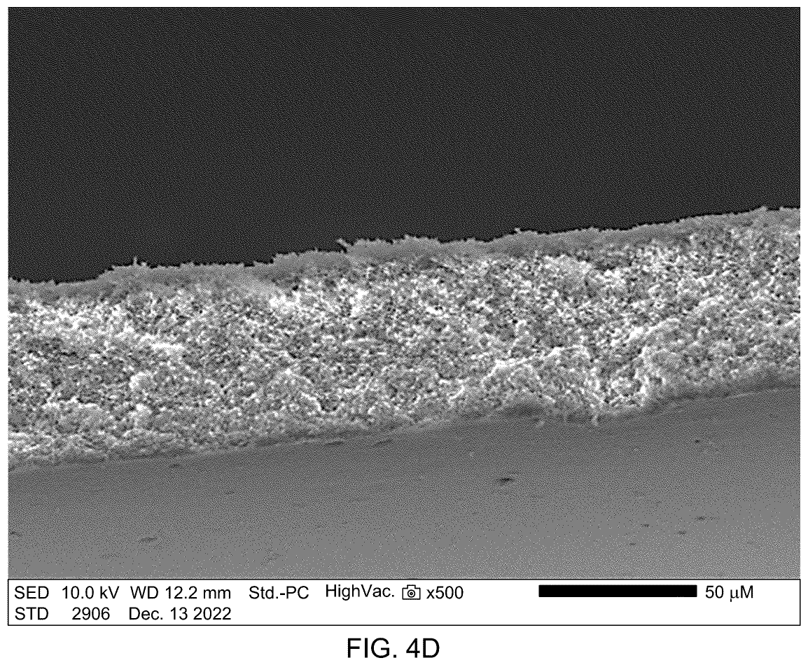

The structures of the polyimide membranes prepared from water and ethanol may be characterized by scanning electron microscope (SEM), respectively. Referring to FIGS. 4A and 4C, the polyimide membrane prepared from water as a non-solvent medium has a plurality of submicron size pores evenly distributed on the surface of the polyimide membrane, and an asymmetric cross-sectional structure comprising a plurality of macro-voids in the form of cells embedded inside the polyimide membrane. In some embodiments, the submicron size pores on the surface of the polyimide membrane have an average pore diameter in a range of 10 to 1000 nm, preferably 20 to 800 nm, preferably 50 to 600 nm, preferably 100 to 400 nm, or even more preferably about 200 nm. In some further embodiments, a first portion of the macro-voids of the asymmetric cross-sectional structure is in the form of closed cell having an average length of 10 to 50 μm, preferably 20 to 45 μm, or even more preferably 30 to 40 μm; an average width of 1 to 15 μm, preferably 3 to 12 μm, or even more preferably 6 to 9 μm; and an aspect ratio (width to height) in a range of 1:50 to 1:1, preferably 1:40 to 1:10, or even more preferably 1:30 to 1:20. Other ranges are also possible. In some other embodiments, a second portion of the macro-voids of the asymmetric cross-sectional structure is in the form of open cell that has one or more submicron size pores opening to the outside on the surface of the membrane. The macro-voids in the form of open cells have an average length of 10 to 60 μm, preferably 20 to 55 μm, or even more preferably 30 to 50 μm; an average width of 1 to 15 μm, preferably 3 to 12 μm, or even more preferably 6 to 9 μm; and an aspect ratio (width to height) in a range of 1:60 to 1:1, preferably 1:50 to 1:10, or even more preferably 1:40 to 1:30.

Referring to FIGS. 4B and 4D, the polyimide membrane prepared from ethanol as a non-solvent medium has a porous structure with rough and fibrous morphology on the surface and symmetric membrane structure in the cross-section.

As used herein, the term “rough morphology,” “surface roughness,” or “Ra surface roughness,” or “Ra” generally refers to arithmetical mean roughness of a surface, which measures the vertical deviations of a real surface from its ideal form. The roughness refers to surface micro-roughness which may be different than measurements of large-scale surface variations. In some embodiments, this may be measured using atomic force microscopy (AFM).

In some embodiments, the porous structure of the polyimide membrane prepared from ethanol as a non-solvent medium has an average surface roughness (Ra) of 10 to 2000 nm, preferably 100 to 1800 nm, preferably 300 to 1500 nm, preferably 500 to 1200 nm, preferably 700 to 1000 nm, or even more preferably about 900 nm. Other ranges are also possible.

In some embodiments, the symmetric cross-sectional structure of the polyimide membrane prepared from ethanol as a non-solvent medium has a dense structure and a plurality of nanosized voids having an average size of 1 to 100 nm, preferably 10 to 80 nm, preferably 15 to 60 nm, or even more preferably 20 to 40 nm. Other ranges are also possible.

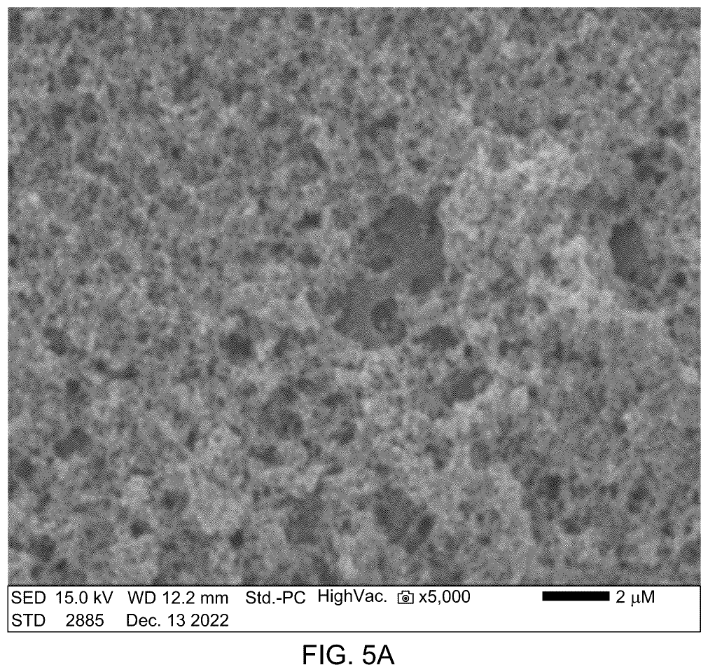

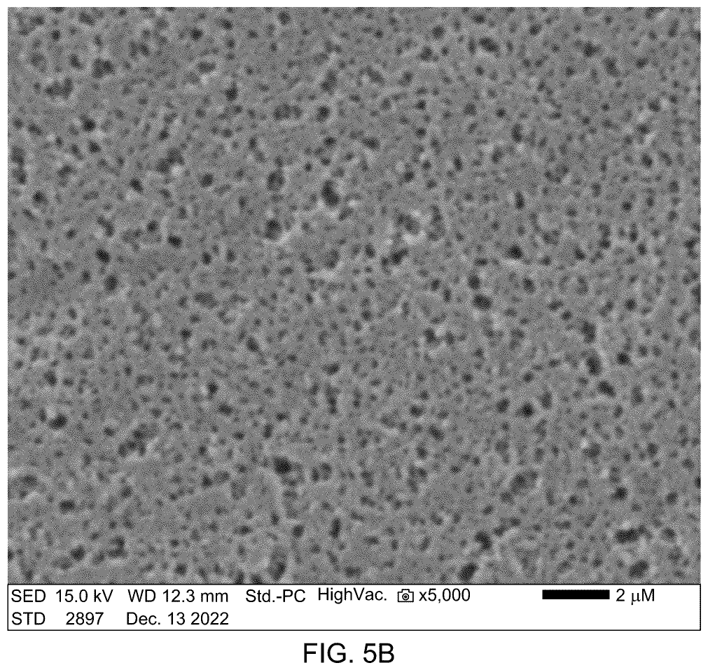

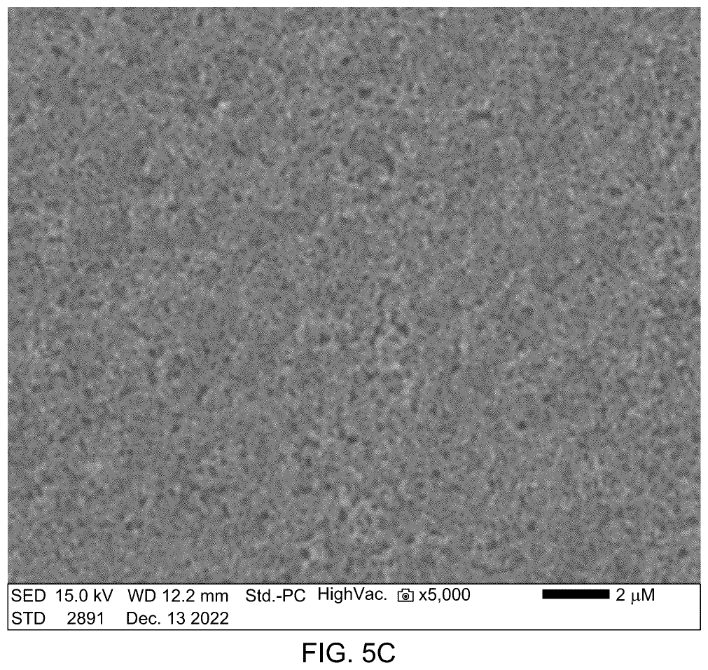

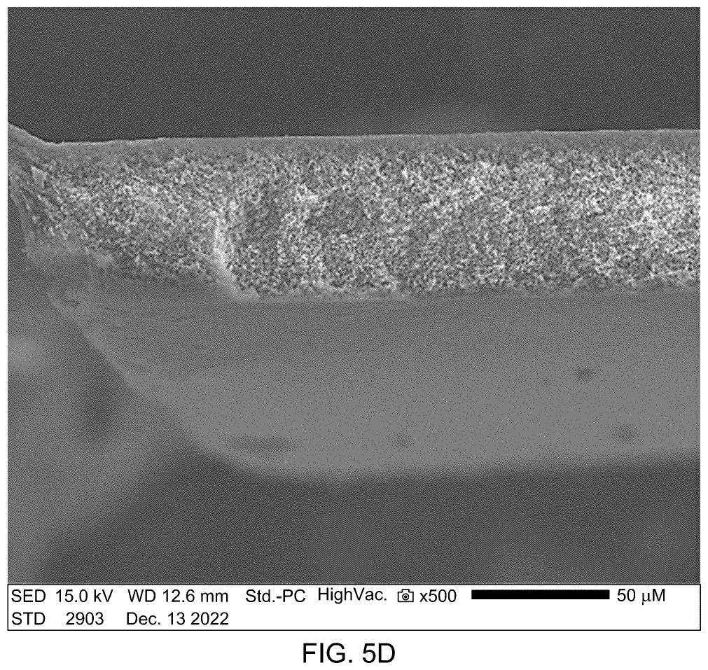

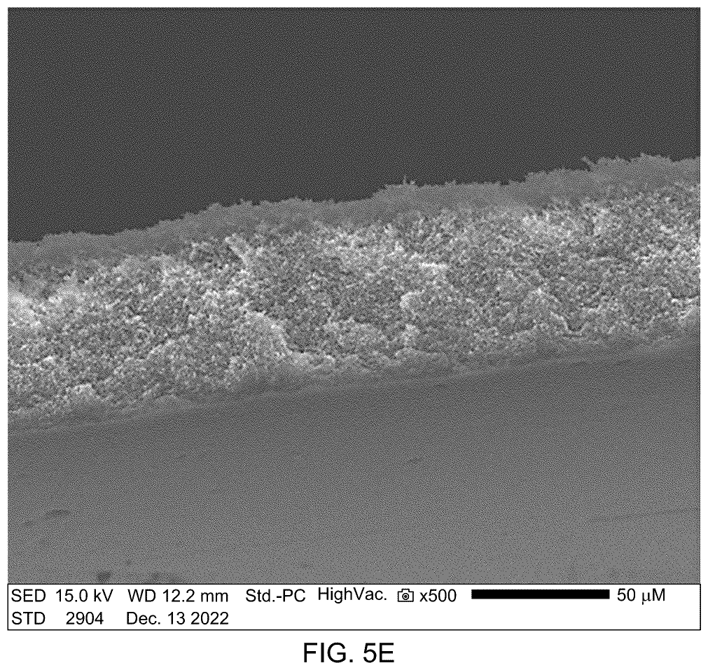

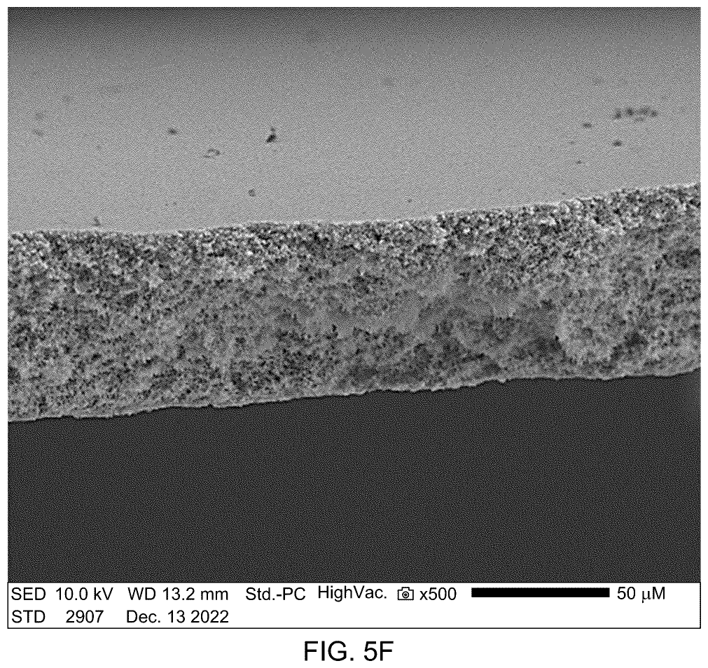

In some further embodiments, referring to FIGS. 5A to 5F, the polyimide membrane fabricated at, preferably 8 wt. % of the polyimide solution, has a non-uniform porous surface structure and a thickness of about 55 μm. In some embodiments, the polyimide membrane fabricated at, preferably 10 wt. %, or even more preferably 12 wt. % of the polyimide solution concentration has a uniform porous surface morphology compared to the polyimide membrane fabricated at preferably 8 wt. % of the polyimide solution, and a thickness of about 60 to 70 μm, preferably 61 to 65 μm. Other ranges are also possible.

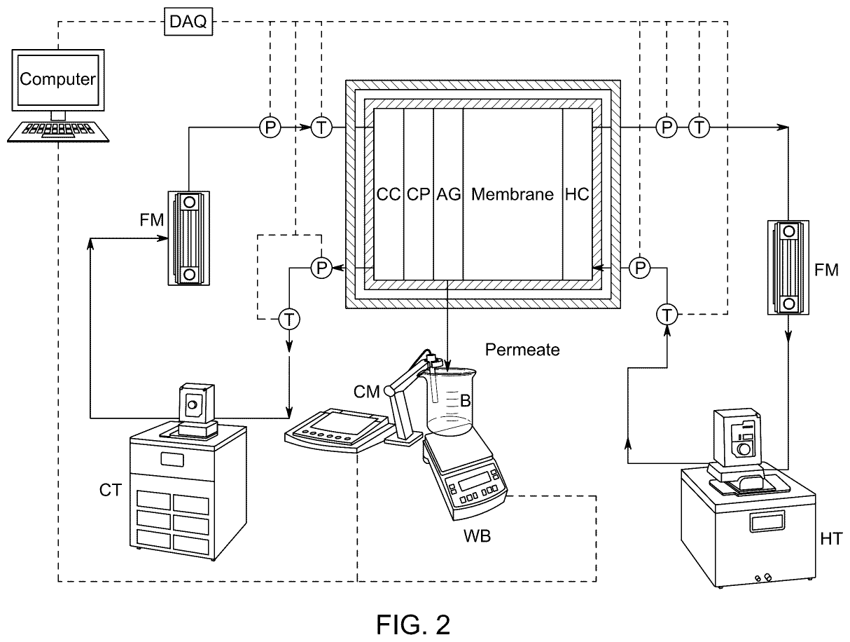

Another aspect of the present disclosure is directed to a desalination system. Referring to FIG. 2, the desalination system (hereinafter referred to as “the system”), includes a water heater, recirculating chiller, thermocouple, data acquisition (DAQ); hot water tank (HT); cold water tank (CT); beaker (B); pump (PM); flowmeter (FM); pressure gauge (P); temperature gauge (T); conductivity meter (CM); weighing balance (WB); and an air gap membrane distillation (AGMD) unit. The AGMD is utilized wherein the water vapor travels through the membrane from the hot feed side (HC) to the cooling plate (CP) and is collected in a beaker after condensation.

The AGMD unit includes two or more modules. Each module includes a hot liquid compartment (HC) having a hot liquid inlet and a hot liquid outlet, and a condensation plate (CP) having a first side and a second side opposite the first side. The polyimide membrane having a thickness of 40 to 80 μm disposed on at least one side of the HC such that one side of the polyimide membrane faces the first side of the CP. The membrane further includes an air gap compartment (AG) separates the CP and the polyimide membrane; and a cold liquid compartment (CC) having a cold liquid inlet and a cold liquid outlet. The CC is adjacent to the second side of the CP. The membrane further includes a permeate outlet in fluid communication with the air gap; a heating unit in fluid communication with the HC; and a cooling unit in fluid communication with the CC. The plurality of modules of the AGMD unit are connected in at least one of a series arrangement or a parallel arrangement.

The system includes two cycles-heating and cooling cycle. During the heating cycle, the feed, saline water, is introduced into the hot liquid inlet of HC through a pump (for example, a centrifugal pump), from a feed water bath, at a pre-determined flow rate. In an example, the feed water bath is heated by at least one selected from a group consisting of a space heater, heating pipes, a furnace, and a boiler, without any limitations. The FM is configured to monitor the flow rate of the feed into the HC. The temperature gauge (T) is configured to monitor the feed temperature, while the pressure gauge (P) is configured to monitor the feed pressure. The saline feed in the HC is heated to around 60-80° C., preferably about 70-75° C., using a water heater. The feed passes through the HC and returns to the feed water bath through the hot liquid outlet for re-heating and re-circulation. The temperature was maintained and monitored by connecting thermocouples to a DAQ.

During the cooling cycle, cold water from the CW is pumped into the CC through the cold liquid inlet to cool down the condensation plate located between the air gap and the CC. The cold water exists the CC through the cold liquid outlet and returns to the CW for re-cooling and re-circulation. The FM is configured to monitor the flow rate of the cold water into the CC. The temperature gauge (T) is configured to monitor the cold water temperature, while the pressure gauge (P) is configured to monitor the cold-water pressure.

The vapor pressure difference (the driving force) is created because of the temperature difference between the HC and CC. The water vapor created at the HC diffuses through the membrane pores and then migrates through the stagnant air staged between the membrane and CP. The vapor comes in contact with the CP and is condensed to form a distillate which is collected in the CC. The distillate is directed outside via a permeate outlet of the AG. The CM with TDS measurement is used to assess the quality of the collected water (distillate) in the beaker. The amount collected in the beaker is weighed at regular intervals to calculate the flux. Both the CM and WB is connected to a computer to record data for long-term test through their respective software.

Another aspect of the present disclosure is directed to a desalination process. Desalination is the process by which the dissolved mineral salts in water are removed with the membrane of the present disclosure. The process includes feeding a liquid into the desalination system through the hot liquid inlet of the HC. The liquid is at least one selected from the group consisting of salty water, ocean/sea water, rejected brine, wastewater, brackish water, flow back/produced water, and waste flows. In a preferred embodiment, the liquid is salty water. The saltwater may contain sodium chloride (NaCl). In an embodiment, the NaCl is present in the salty water at a concentration of 0.1 to 100 grams per liter (g/L) based on the total volume of the salty water, preferably 20 to 80 g/L, preferably 40 to 60 g/L, or even more preferably about 50 g/L. Other ranges are also possible. In this desalination process, the hot liquid passes through the membrane, which allows hot water vapor to pass through the membrane while rejecting the mineral salts, such as NaCl. The water vapor passes through the air gap and is condensed on the CP. The CP may be cooled by a cold stream, or in multistage configurations, by feed streams at progressively lower temperatures. The condensed water (distillate/permeate) is further collected from the permeate outlet.

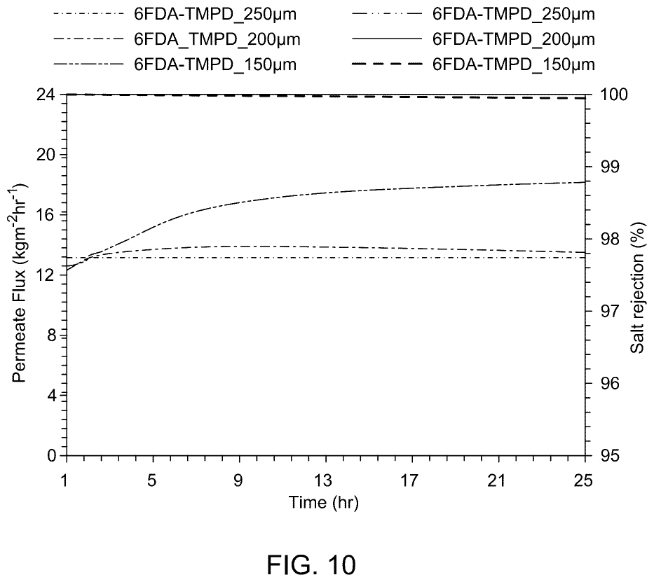

FIG. 10 illustrates membrane thickness on rejection and permeate flux of the polyimide membrane fabricated with 10 wt. % concentration of the 6FDA-TMPD polymer. In some embodiments, the polyimide membrane has a permeate flux of 9 and 15 kg/m²hr, preferably 10 to 13 kg/m²hr, or even more preferably about 11 kg/m²hr at a thickness of 150 to 250 μm. In some embodiments, the polyimide membrane has a salt rejection of up to 90 wt. %, preferably up to 95 wt. %, or even more preferably up to 99 wt. % based on an initial concentration of the salt solution. Other ranges are also possible.

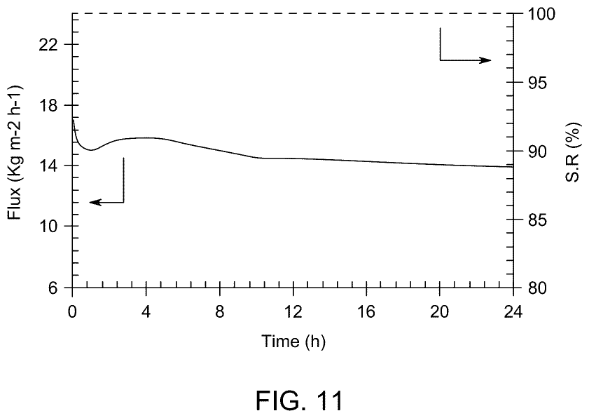

Referring to FIG. 11 illustrates flux and rejection for the 6FDA-TMPD membrane tested with seawater having a concentration of 70 g/L at a feed temperature of about 70° C. The 6FDA-TMPD membrane has a permeate flux of about 14 kg/m²hr over a period time of 1 to 48 hours, preferably 4 to 36 hours, or even more preferably about 24 hours. Other ranges are also possible.

### EXAMPLES

The following examples demonstrate the membrane, as described herein. The examples are provided solely for illustration and are not to be construed as limitations of the present disclosure, as many variations thereof are possible without departing from the spirit and scope of the present disclosure.

### Example 1: Materials

4,4′-(hexafluroisopropylidene)diphthalic anhydride (6FDA), 2,3,5,6-tetramethyl-p-phenylenediamine (TMPD), Dimethyl dimethyl formamide (DMF) with purity >99% from scientific laboratory supplies, de-ionized deionized water (DI) mixed with 2-propanol with a purity of 99.8% from PanReac-AppliChem are used as solvent and nonsolvent respectively. DI water from the Millipore system was used for fabrication and membrane testing.

### Example 2: Synthesis of 6FDA-TMPD Polymer

6FDA-TMPD was prepared using a one-step high-temperature polycondensation reaction. An equimolar amount (18 mmol) of both reagents (i.e., 6FDA and TMPD) were added into a 2-neck round bottom flask, followed by adding m-cresol under continuous nitrogen flow. The reaction was heated gradually to 200° C., and the polyimide solution was poured onto methanol. Reprecipitation of polyimide from its chloroform solution was carried out three times to ensure the removal of m-cresol and impurities to afford white fibers.

### Example 3: Fabrication of Polyimide Membranes

Referring to FIG. 3, a schematic of the membrane fabrication process is depicted. 6FDA-TMPD polymer with different dope solution concentrations (8,10, and 12 wt. %) was dissolved in N, N-dimethylformamide (DMF) and stirred for 12 h at room temperature using a magnetic stirrer (302). The solution was degassed at the same temperature for 6 h without stirring to remove bubbles produced during mixing and to ensure the quality of membranes by avoiding defects in the membrane. Membranes were fabricated using the non-solvent-induced phase inversion. The polymer solution was spread on a glass surface with a varying casting thickness (304). Then it was immediately immersed in a coagulation bath. Two different nonsolvent coagulation mediums were used—the first is the water bath containing DI water maintained at 30° C. temperature, and the other coagulation process involves immersing the membrane in ethanol for two minutes before dropping it in the water bath (306). After the de-mixing process, the precipitated membranes were taken out after about 10 minutes and kept in another DI water bath for 24 hrs. The resulting membranes were then rinsed several times in deionized water and dried under filter papers for 24 h at room temperature (308). After this, the membranes were post-treated to remove any traces of solvent and water by drying them in a vacuum oven at 150° C. (310) to obtain the membrane (312).

Different concentrations of the polymer were prepared to compare the performance in MD. Polymer concentrations of 8, 10, and 12 wt. % solutions and varying thicknesses of 150 μm, 200μ m, and 250 μm was used. The preparation conditions for the solution and membrane fabrication are shown in Table 1 below.

TABLE 1
Membrane fabrication conditions.

| Membrane casting condition | Parameters |
|---|---|
| Solution composition (wt. %) | 6FDA-TMPD (8 wt. %, |
| | 10 wt. % and 12 wt. %) |
| Mixing time of solution (h) | 12 h |
| Mixing temperature of the | 30° C. |
| solution (° C.) | |
| Casting thickness (base) | 150-250 μm |
| Coagulation bath (wt. %) | Ethanol, DI water |
| Coagulation temperature (° C.) | 30° C. |
| Casting temperature of the | Room temperature |
| membrane (° C.) | |
| Drying time (h) | 24 h (room temperature) |
| Drying temperature (h) | 150° C. in a vacuum oven |
| | to remove any moisture. |

### Example 4: Membrane Characterization

The morphologies of the membrane surface and cross-section were analysed using a scanning electron microscope (SEM) from JEOL. The membranes were coated to prevent charging on the surface during analysis. The surface property was investigated using Fourier transforms infrared (FT-IR) spectroscopy to characterize the chemical nature of the polyimide membranes. The water contact angle (WCA) was obtained by the sessile drop method on the membrane surface conducted on a contact angle goniometer instrument (DM-501, Kyowa Interface Science Co. Ltd., Japan). The WCA was taken on four different positions, and the average value was recorded. The thickness of the membranes was recorded by taking measurements from 10 different spots on the membrane to generate accurate data using LITEMATIC VL-50A from Mitutoyo measuring instrument. Readings were taken in 10 different spots to generate accurate data. The liquid entry pressure (LEP) was determined using a laboratory setup to evaluate the membrane wetting resistance by pressurizing a small chamber of water against membranes as described by Smolder and Franklin [Smolders K, Franken ACM. Terminology for Membrane Distillation. vol. 72. 1989, which is incorporated herein by reference in its entirety]. The pressure at which water penetrates the membrane pores and the droplet seen at the surface is determined. A capillary flow porometer (3 Gzh, Quantachrome Instrument, USA) was used to characterize the pore size of the membranes by the expulsion of liquid (porofil) through gas pressure. Membranes were first soaked to fill the pores of membranes with the porofil liquid, also known as the wetting liquid. Pore size and pore size distribution of the membranes were reported through this process. The porosity of membranes “E” was determined by the gravimetric method as reported by [Gu M, Zhang J, Wang X, Tao H, Ge L. Formation of poly(vinylidene fluoride) (PVDF) membranes via thermally induced phase separation. Desalination 2006; 192:160-7, which is incorporated herein by reference in its entirety]. The membranes were weighed before and after soaking them in isopropanol liquid. After fully soaked, residual isopropanol was removed from the surface of the membranes with filter papers. The porosity is calculated based on the equation below.

$$ε \% = \frac{( {w}_{w} - {w}_{d} ) / {d}_{p}}{[ ( {w}_{w} - {w}_{d} ) / {d}_{p} ] + ( {w}_{d} / {d}_{m} )} \qquad eq . ( 1 )$$

Where ε% is the membrane porosity, w_{w} is the weight of wet and w_{d} is the weight of dry membrane. dₚ and dₘ are the density of isopropanol (0.785 g/cm³) and polymer (6FDA-TMPD is (1.2 g/cm³) respectively.

### Example 5: Membrane Distillation Test

A Membrane Distillation (MD) test was carried out to evaluate the performance of the different compositions of fabricated membranes using a lab-scale air-gap membrane distillation (AGMD) experimental setup. The setup includes water heater, recirculating chiller, weighing balance (WB), thermocouple, flow meter (FM), data acquisition (DAQ); hot water tank (HT); cold water tank (CT); beaker (B); pump (PM); flowmeter (FM); pressure gauge (P); temperature gauge (T); airgap (AG); condensation plate (CP); cold water compartment (CC); conductivity meter (CM); weighing balance (WB); and MD cell. The feed side of the cell was supplied with a hot feed stream through a constant temperature water heater (Julabo 601F), while the chiller from the same product provided the coolant on the other side of the cell. The hot and cold feed compartment is made up of acrylic material with channel dimensions of (4*4*0.5) cm each. DI water and NaCl solutions were used as the coolant and feed, respectively. Flowmeter (FM) was installed to monitor the flow rate of the feed and coolant stream. The high saline water of 70,000 ppm used as the feed was prepared in the lab by dissolving 0.7 kg of NaCl (99.98%, chem lab Belgium) in 10 L of DI water. The feed (saline) water was then transferred to the heater compartment and heated to a temperature of 70° C. The temperature was maintained and monitored by connecting thermocouples to a data acquisition system (DAQ). The fabricated membranes were then tested for more than 24 hrs and recorded in real-time using a computer system. The concentration and the mass of the permeate were recorded using Hanna HI5321 conductivity/TDS meter and Ohaus PR2200 precision top loading balance, respectively. The performance of the fabricated membranes was tested using highly saline feed water of 70 g/L. All the membranes were tested in the same conditions as shown in Table 2 below:

TABLE 2
Process conditions for membrane testing in
highly saline water using AGMD setup.

| Parameters | Values | Units |
|---|---|---|
| Feed salinity | 70 | g/L |
| Feed Temperature | 70 ± 0.6 | ° C. |
| Feed flow rate | 0.8 | L/min |
| Coolant Temperature | 19 ± 0.3 | ° C. |
| Coolant flow rate | 2.0 | L/min |
| Airgap width | 5.0 | Mm |
| Effective membrane area | 7.316 × 10⁻⁴ | m² |

The membrane productivity is the measure of the quantity of water permeating through a specific area of the membrane surface in a given time. The productivity is characterized by the permeate flux. The permeate flux of the membrane is calculated from Equation 2.

$$\begin{matrix}J = \frac{Δ m}{A . t} & ( {kgm}^{- 2} {h}^{- 1} )\end{matrix} \qquad eq ( 2 )$$

Where Δm is the mass of collected permeate in kg, A is the effective area in m², and t is the time taken for permeate collection estimated in hours, and J is the permeate flux in (kg/m²h).

The salt rejection S.R is calculated using equation 3.

$$S . R ( \% ) = \frac{{C}_{f} - {C}_{p}}{{C}_{f}} \qquad eq . ( 3 )$$

Where S.R, C_{f} and Cₚ are the salt rejection (%), the concentration of feed in ppm, and the concentration of permeate in ppm, respectively.

### Example 6: Morphology and Chemical Nature of 6FDA-TMPD Membranes

The morphology of the membranes fabricated by water and ethanol-based non-solvent-induced phase inversion process was evaluated through the SEM analysis. The cross-section of the membranes was also examined after gently breaking the membranes in liquid nitrogen. Initially, the surface of membrane samples obtained from water and ethanol coagulation bath was examined. FIG. 4. shows the surface and cross-sectional images of these samples. It is observed from FIG. 4A (surface SEM image) and FIG. 4C (cross-sectional SEM image) that the membrane fabricated from water as a non-solvent medium typically shows an asymmetric structure in the cross-section with near submicron size pores visible on the surface at higher magnification, while the membrane sample from ethanol non-solvent medium showed a porous structure with rough or fibrous morphology on the surface and symmetric membrane structure in the cross-section (FIG. 4B and FIG. 4D). The submicron size pores on the surface of the polyimide membrane have an average pore diameter in a range of 10 to 1000 nm, preferably 20 to 800 nm, preferably 50 to 600 nm, preferably 100 to 400 nm, or even more preferably about 200 nm. A portion of the macro-voids of the asymmetric cross-sectional structure is in the form of closed cell having an average length of 10 to 50 μm, preferably 20 to 45 μm, or even more preferably 30 to 40 μm; an average width of 1 to 15 μm, preferably 3 to 12 μm, or even more preferably 6 to 9 μm; and an aspect ratio (width to height) in a range of 1:50 to 1:1, preferably 1:40 to 1:10, or even more preferably 1:30 to 1:20. Another portion of the macro-voids of the asymmetric cross-sectional structure is in the form of open cell that has one or more submicron size pores opening to the outside on the surface of the membrane. The macro-voids in the form of open cells have an average length of 10 to 60 μm, preferably 20 to 55 μm, or even more preferably 30 to 50 μm; an average width of 1 to 15 μm, preferably 3 to 12 μm, or even more preferably 6 to 9 μm; and an aspect ratio (width to height) in a range of 1:60 to 1:1, preferably 1:50 to 1:10, or even more preferably 1:40 to 1:30. This difference in the structure of the membrane can be attributed to the variation in the demixing rate of water and ethanol as non-solvent with the DMF solvent during the phase inversion process. Moreover, it can be seen from these SEM images that the membrane fabricated using ethanol as a coagulation medium showed a relatively more interconnected porous structure compared with the water medium. Since water is a non-solvent for DMF, it had a fast-demixing rate resulting in macro-voids and a smooth surface, contrary to ethanol which acts as a soft non-solvent for DMF. Consequently, different polymer compositions were also examined to obtain the porous membranes (with desired porosity) for MD application after ethanol coagulation medium.

FIG. 5 shows the SEM images of membranes fabricated at different polymer concentrations. Typically, all membranes had a symmetric structure with variation in surface porosity. Membrane at 8 wt. % conc. (FIG. 5A) showed a non-uniform porous structure on the surface, whereas a uniform porous morphology can be seen at 10 wt. % (FIG. 5B). On the other hand, at 12 wt. % (FIG. 5C), the structure changed to a highly dense due to higher polymer concentration. It also can be observed in the cross-sectional images (FIGS. 5D-5F) where the membranes at 8 wt. %, 10 wt. %, and 12 wt. % conc. has an average thickness of approximately 55μ m, 61.5 μm, and 65 μm, respectively. This variation in thickness and porosity for the membrane after drying (with constant casting thickness) can be attributed to the difference in the concentration where the polymer-rich solution film hinders the escape of solvent or lower the demixing rate, consequently generating a dense and thicker membrane.

The chemical structures of 6FDA-TMPD membranes fabricated via the phase inversion process are crucial to obtain desired porous network. The membranes were dried in a vacuum to remove any traces of solvents trapped inside the pores. FT-IR spectroscopy was used to characterize the chemical nature of the polyimide membranes. FIG. 6 shows the spectra of the 6FDA-TMPD membrane in ethanol and water nonsolvent as 6FDA-TMPD EtOH and 6FDA-TMPD_water, respectively. The FTIR spectrum shows that the polyimide functional group, with C—H absorption band of 2800-3000 cm⁻¹, symmetric and asymmetric absorption bands of carbonyl(C═O) group at 1780 and 1718 cm⁻¹, respectively, whereas the C—N absorption band was observed at 1348 cm⁻¹. There were no changes in the peak of the two membranes from water and ethanol which shows that there was no alterations in the chemical structures of the membrane fabricated through ethanol coagulation bath.

### Example 7: Membrane Wetting Behavior and Bulk Properties

The properties exhibited by the polymeric membranes determine their performance in MD testing. These properties include but are not limited to the wetting behavior, LEP, pore size, and pore structure in the membranes. The wetting behavior of the 6FDA-TMPD membranes was examined using a goniometer instrument that measures the contact angle. The goniometer instrument uses a high-accuracy monochromatic camera to capture the image and soft white light on the other side to depict the contact angle accurately. The samples were set flat under the tip of the instrument while facing the optics, and then a sessile drop method on the membranes at five different locations was carried out; thereafter, the average value was recorded. The contact angle of 6FDA-TMPD in water and ethanol are 75 and 95, respectively, as shown in FIG. 7A and FIG. 7B. Ethanol-based phase inversion membranes showed an increase in contact angle or hydrophobicity as compared to that of water due to rough and porous surface structure. The hydrophobicity was further demonstrated by different concentrations of 6FDA-TMPD polymer i.e., 8, 10, and 12 wt. %, as shown in FIG. 7C-FIG. 7E, respectively.

The contact angle at varying concentrations of 6FDA-TMPD i.e., 8,10,12 wt. %, remains hydrophobic at 93.3°, 94.8°, and 97.7°, respectively. The increase in the contact angle with higher polymer concentration was because of the rich rough structure formed on the surface of 6FDA-TMPD membranes after inserting them in an ethanol bath. The liquid entry pressure property of the membranes was measured by gradually pressurizing air on the membrane surface using a deionized water-contained chamber. LEP depends on the size and shape of the pore, hydrophobicity, and pore structure. The pressure at which a droplet was noticed on the surface of the membrane was recorded underside the chamber. This was done for example, preferably 3 samples, and the average was recorded as the LEP. The LEP of water-based phase inversion membranes showed low LEP as compared to ethanol-based due to its low hydrophobicity. The pressure at which water penetrates the membrane pores is determined, and the water droplet is seen at the surface. The thickness of the membranes was recorded in different locates using (LITEMATIC VL-50A, Mitutoyo) measuring instrument. Readings were taken in for example, preferably 10 different spots to generate accurate data. The thickness of the membranes is between 58 μm to 80 μm. The membranes developed from 6FDA-TMPD polymer showed porosity between 80 and 89%, which indicates that the membranes have a porous network. 6FDA-TMPD membranes from ethanol nonsolvent have a higher porosity than water.

TABLE 3
Properties of 6FDA-TMPD membranes in
water and ethanol coagulation bath.

| | LEP | Thickness | Max. pore | Porosity |
|---|---|---|---|---|
| Membranes | (bar) | (μm) | size (μm) | (ε%) |
| 6FDA-TMPD in water | 1.3 ± 0.1 | 66.30 ± 5 | 0.13 | 80.64 |
| 6FDA-TMPD in | 1.8 ± 0.1 | 68.50 ± 8 | 0.16 | 84.33 |
| ethanol | | | | |

TABLE 4
Properties of 6FDA-TMPD polyimide membranes cast on
glass for different concentrations of 8, 10, and 12 wt. %.

| | LEP | Thickness | Max. pore | Porosity |
|---|---|---|---|---|
| Membranes | (bar) | (μm) | size (μm) | (ε%) |
| 6FDA-TMPD_8 wt % | 0.7 + 0.1 | 58.5 ± 7 | 0.25 | 89.05 |
| 6FDA-TMPD_10 wt % | 1.8 ± 0.1 | 68.50 ± 8 | 0.16 | 84.33 |
| 6FDA-TMPD_12 wt % | 1.9 ± 0.1 | 79.5 ± 10 | 0.15 | 84.00 |

TABLE 5
Properties of 10 wt. % 6FDA-TMPD polyimide membranes
cast on glass for varying thickness.

| | LEP | Max. pore | Thickness | Porosity |
|---|---|---|---|---|
| Sample (10%) Thickness | (bar) | size (μm) | (μm) | (ε%) |
| 6FDA-TMPD in ethanol, | 1.2 ± 0.1 | 0.20 | 43.8 ± 8 | 86.00 |
| 150 μm | | | | |
| 6FDA-TMPD in ethanol, | 1.8 ± 0.1 | 0.16 | 68.50 ± 8 | 84.33 |
| 200 μm | | | | |
| 6FDA-TMPD in ethanol, | 1.9 ± 0.1 | 0.15 | 78 ± 6 | 82.80 |
| 250 μm | | | | |

According to Tables 3 to 5, the polyimide-based membranes had a pore size range between 0.10 and 0.25 μm. The membrane pore size is higher in an ethanol bath than in water due to high porosity and interconnected structure. The 8 wt. % membrane has shown the largest pore size as compared to others. There is a close range of pore size between membranes formed between 10 wt. % and 12 wt. %, which gives a stable performance during testing. Demixing occurs after the contact between the polymer solution and the nonsolvent. Membrane pores are formed quickly after immersion in the nonsolvent medium. The changing of the coagulation bath and the varying concentration of the casting solution modified the pore size distribution of developed membranes.

### Example 8: Performance of 6FDA-TMPD Membranes in Airgap Membrane Distillation

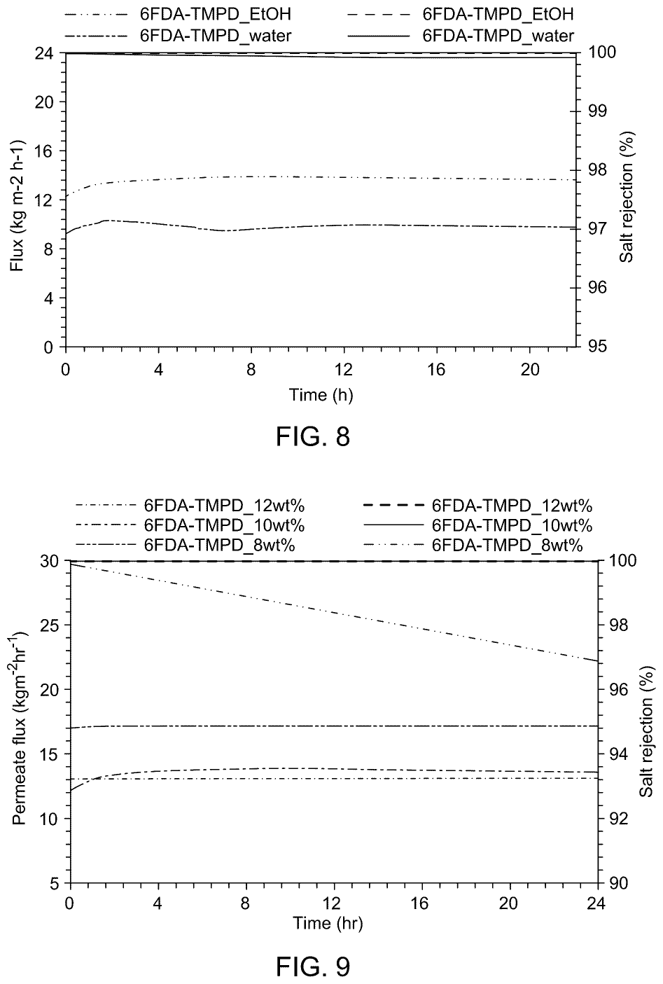

6FDA-TMPD membranes fabricated were tested in highly saline water of 70 g/L NaCl (70000 ppm). The performance of 6FDA-TMPD polyimide membranes in water and ethanol was analyzed in the MD distillation unit. 6FDA-TMPD in water and ethanol has a flux of 9.90 kg/m²h and 13.6 kg/m²h, respectively. There was an improved and stable rejection at 99.98 and 99.99%, respectively, as shown in FIG. 8. The membranes fabricated from 6FDA-TMPD in ethanol shows improved result due to the porous nature and increase in hydrophobicity of the membranes. The increase in hydrophobicity was because of the roughness provided by ethanol on the surface of the developed membranes. Changing the coagulation bath improved the performance of the fabricated membranes.

The concentrations of 6FDA-TMPD membranes were tested and compared for 8, 10, and 12 wt. % in an ethanol nonsolvent medium, which exhibited high permeate flux of 17.17 Kg/m²h, 13.60 Kg/m²h, and 13.20 Kg/m²h, respectively. 6FDA-TMPD membranes of 10 wt. % and 12 wt. % showed high flux and good and stable rejection of 99.99% and 98% for 8 wt. % concentration respectively, as shown in FIG. 9. The reduction in the salt rejection and increase in permeate flux for 8 wt % was due to the large pores created in the membrane by the removal of DMF solvent during the phase inversion process in ethanol and as well as drying in a vacuum oven. 6FDA-TMPD_10 wt % exhibited improved results in terms of salt rejection and flux. The polymer concentration which may influence the structure and performance of the membrane, as depicted in the 6FDA-TMPD membrane. Increasing the polymer concentration in the casting solution produces membranes with dense surfaces exhibiting high rejection and low flux. This can be seen from the 6FDA-TMPD membrane performance as shown by 6FDA-TMPD 12 and 6FDA-TMPD_10 compared to 6FDA-TMPD_8 wt %, which has the highest flux.

Further MD experiment was performed to check the effect of casting thickness of 6FDA-TMPD 10 wt % membranes in ethanol nonsolvent medium and enhance the permeate flux in MD (FIG. 10). An improvement in the flux to 16.70 Kg/m²h was observed for the membrane having a thickness of 150 μm. This enhancement was due to the increase in the pore size reaching 0.20 μm as compared to the other thickness, which is between 0.15 μm and 0.16 μm. The salt rejection was observed to be stable for more than 24 hours. The variation in the casting thickness was examined to produce an optimal thickness of the membranes with improved performance. Reducing the casting thickness of the 6FDA-TMPD developed membranes in an ethanol nonsolvent to 150 μm resulted in an ideal thickness with better performance. The process performance of membranes can be enhanced by reducing membrane thickness up to a certain point without significant improvement.

Further, the durability of the membranes is assessed by using highly saline water (70,000 ppm) at a feed temperature of 70° C. The test was run for 24 h, which was substantial to check the durability of the developed membrane. Notably, the MD process utilizes lower operating pressures, unlike RO desalination systems. The membrane was also tested on real seawater collected from Khobar Sea front. The seawater contained different types of salts with minor quantities of particulates. The MD test result with real seawater as feed is shown in FIG. 11. The MD test depicts 99.99% rejection with an average flux of 14 kg m⁻² h⁻¹. No significant drop in flux or rejection was noted, which depicts antifouling characteristics for the developed membrane.

The membrane of the present disclosure is hydrophobic in nature. The target application for this membrane is to desalinate highly saline water through (MD) technology. In MD, the membrane essentially must resist water going through it and only allows water vapor to permeate on the other side of the membrane. Any contaminants, toxic elements, dissolved solid, etc., if present, is easily observed in the collected water after condensation. Since a conductivity/TDS meter is placed to record the quality of water, total dissolved solids (TDS) in ppm are recorded. The result of MD test performed on the developed membrane showed a rejection of >99.9% with a recorded TDS of less than 100 ppm. This is an ultra-pure water obtained from high saline water. Hence, the developed membrane is considered non-toxic.

The 6FDA-TMPD polymer membrane has shown improved performance in water desalination via the membrane distillation method. The developed membrane at 10 wt. % polymer conc. and 150 μm casting thickness has shown stable salt rejection with permeate flux reaching 16.70 Kg/m²h. 6FDA-TMPD membranes were developed using the phase inversion method to obtain a porous network without pore-forming agents or other additives. The membrane was developed from water and ethanol as a non-solvent medium, and different composition of the polymer was also investigated to obtain the porous membrane for MD application. The ethanol-based coagulation bath membranes with 10 wt. % and 200 μm thickness showed an excellent MD performance with high permeate flux reaching 13.6 kg/m²hr and stable salt rejection of 99.99%. The membrane characteristics were examined by reducing the thickness to achieve a permeate flux of 16.70 Kg/m²h and stable rejection of 99.97% for more than 24 h. The results show that the selection of 6FDA-based polyimide for porous membrane synthesis and ethanol as a non-solvent had a significant impact on the performance of the membranes.

Numerous modifications and variations of the present disclosure are possible in light of the above teachings. It is therefore to be understood that within the scope of the appended claims, the invention may be practiced otherwise than as specifically described herein.

1. A method of making a polyimide membrane, comprising:
mixing at least one dianhydride monomer and at least one phenylenediamine monomer in a first solvent to form a mixture;
wherein a molar ratio of the dianhydride monomer and the phenylenediamine monomer present in the mixture is in a range of 1:5 to 5:1;
heating the mixture thereby polymerizing the dianhydride and phenylenediamine monomers to form a polyimide polymer in a crude mixture;
precipitating the polyimide polymer from the crude mixture to separate the polyimide polymer from the crude mixture;
mixing and dissolving the polyimide polymer in a second solvent to form a polyimide solution;
applying the polyimide solution onto a surface of a substrate to form a polyimide liquid layer on the substrate;
immersing the substrate after the applying in at least one liquid medium selected from the group consisting of water and an alcohol, thereby precipitating the polyimide polymer from the polyimide solution to form the polyimide membrane disposed on the surface of the substrate; and
removing the polyimide membrane from the surface of the substrate;
wherein the polyimide membrane has a thickness in a range of 30 to 100 micrometers (μm).

2. The method of claim 1, wherein the dianhydride is at least one selected from the group consisting of 4,4′-(hexafluoroisopropylidene)diphthalic anhydride (6FDA), 4,4′-(4,4′-isopropylidenediphenoxy)bis(phthalic anhydride), and benzophenone-3,3′,4,4′-tetracarboxylic dianhydride, and wherein the mixture consists of the dianhydride monomer, the phenylenediamine monomer and the solvent.

3. The method of claim 1, wherein the phenylenediamine is a p-phenylenediamine having a formula (I) 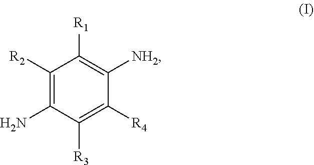
wherein R₁, R₂, R₃, and R₄ are each independently selected from the group consisting of a hydrogen, a hydroxy, an optionally substituted alkyl, an optionally substituted cycloalkyl, and an optionally substituted alkoxy, and wherein the polyimide consists of reacted units of the dianhydride monomer and the phenylenediamine monomer.

4. The method of claim 3, wherein the phenylenediamine is 2,3,5,6-tetramethyl-p-phenylenediamine (TMPD).

5. The method of claim 1, wherein the first solvent is at least one selected from the group consisting of m-cresol, o-cresol, p-cresol, 3,4-xylenol, 2,6-xylenol, and 2,5-xylenol; wherein the second solvent is at least one selected from the group consisting of dimethylformamide (DMF), and dimethyl sulfoxide (DMSO); and wherein the liquid medium is at least one selected from the group consisting of methanol, ethanol, n-propanol, i-propanol, n-butanol, and tert-butanol.

6. The method of claim 1, wherein the heating is performed at a temperature of 180 to 220° C.

7. The method of claim 1, wherein the polyimide polymer is present in the polyimide solution at a concentration of 1 to 20 wt. % based on a total weight of the polyimide solution.

8. The method of claim 1, wherein the polyimide membrane has a thickness in a range of 40 to 80 μm.

9. The method of claim 1, wherein the polyimide membrane prepared from water as a non-solvent medium has a plurality of submicron size pores evenly distributed on the surface of the polyimide membrane, and an asymmetric cross-sectional structure comprising a plurality of macro-voids in the form of cells embedded inside the polyimide membrane.

10. The method of claim 9, wherein a first portion of the macro-voids of the asymmetric cross-sectional structure is in the form of closed cell having an average length of 10 to 50 μm and an average width of 1 to 15 μm; and wherein a second portion of the macro-voids of the asymmetric cross-sectional structure is in the form of open cell that has one or more submicron size pores opening to the outside on the surface of the polyimide membrane.

11. The method of claim 1, wherein the polyimide membrane has a porous surface with a maximum pore size of 0.1 to 0.3 μm.

12. The method of claim 1, wherein the polyimide membrane has a porosity of 80 to 90% based on a total volume of the polyimide membrane.

13. The method of claim 1, wherein the polyimide membrane has a water contact angle of 93 to 98 °.

14. The method of claim 1, wherein the polyimide membrane has a liquid entry pressure (LEP) in a range of 0.5 to 2.5 bar as determined by a capillary flow porometer.

15. The method of claim 1, wherein the polyimide membrane has a permeate flux of 9 and 15 kg/m²hr.

16. A desalination system, comprising:
an air gap membrane distillation (AGMD) unit having a plurality of modules, and each module comprises:
a hot liquid compartment (HC) having a hot liquid inlet and a hot liquid outlet;
a condensation plate (CP) having a first side and a second side opposite the first side;
the polyimide membrane of claim 1 having a thickness of 40 to 80 μm disposed on at least one side of the HC, wherein one side of the polyimide membrane faces to the first side of the CP;
an air gap compartment (AG) separates the CP and the polyimide membrane;
a cold liquid compartment (CC) having a cold liquid inlet and a cold liquid outlet, wherein the CC is adjacent to the second side of the CP;
a permeate outlet in fluid communication with the air gap;
a heating unit in fluid communication with the HC; and
a cooling unit in fluid communication with the CC.

17. The desalination system of claim 16, wherein the plurality of modules of the AGMD unit are connected in at least one of a series arrangement or a parallel arrangement.

18. The desalination system of claim 16, wherein water produced from the first side of the CP of the module is collected at a permeate tank via a permeate outlet of the AG of the same module.

19. A desalination process, comprising:
feeding a liquid into the desalination system of claim 16 through the hot liquid inlet of the HC; and
collecting distilled water from the permeate outlet;
wherein the liquid is at least one selected from the group consisting of salty water, ocean/sea water, rejected brine, wastewater, brackish water, flowback/produced water, and waste flows.

20. The desalination process of claim 19, wherein the liquid is a salty water containing sodium chloride (NaCl), and wherein the NaCl is present in the salty water at a concentration of 0.1 to 100 grams per liter (g/L) based on a total volume of the salty water.
